(19) United States
(12) Patent Application Publication
(10) Pub. No.: US 2011/0225142 A1
(43) Pub. Date: Sep. 15, 2011

(54) WEB SITE ANALYSIS SYSTEM AND METHOD

(75) Inventor: Craig Edward McDonald, South Yarra (AU)

(73) Assignee: MAILGUARD PTY LTD, South Melbourne (AU)

(21) Appl. No.: 13/046,206

(22) Filed: Mar. 11, 2011

Related U.S. Application Data
(60) Provisional application No. 61/312,716, filed on Mar. 11, 2010.

(51) Int. Cl. G06F 17/30

(52) U.S. Cl. 707/710; 707/E17.108

(57) ABSTRACT

The present invention provides web site analysis system and method. A crawler is adapted to download data of a target web site and associated with a target web site for security analysis to provide a data set for analysis. A process controller controls a plurality of data analysis processes, each data analysis process associated with one of a plurality of analysis functions related to web site security and integrity, and each data analysis process is adapted to identify data relevant for its associated analysis function from within the data set for analysis. An analyser aggregates the data identified by each of the data analysis processes, and analyses the aggregated data to perform each of the analysis functions to identify indications of any potential security and integrity problems. A report of potential security problems can be automatically generated from the analysed data.

### CROSS-REFERENCE TO RELATED APPLICATIONS

This is a non provisional of U.S. Provisional Application Ser. No. 61/312,716 filed on Mar. 11, 2010 the contents of all of which are incorporated herein by reference.

### TECHNICAL FIELD

The technical field of the invention is Internet security, in particular security of web sites.

### BACKGROUND

Widespread use of the Internet for business operations and communication is now an accepted fact of life. The need for protection of computer networks, communications systems and data from corruption and theft is generally accepted.

It is routine practice to filter an organisation's email traffic for viruses and spam. Organisations and individuals are also known to use web-browsing filters to protect against the risk of downloading viruses, malware (malicious software) and phishing attempts. Such filters reduce the risk of security compromise for a browsing user.

Organisations engage in extensive online activities often accessed by customers via an organisation's web sites. An organisation's web site can be a powerful commercial tool. Further an organisation's web site is a first line interface to the organisation's customers. A web site can therefore convey an impression of the organisations values, capabilities and personality which may influence customers. Organisations therefore need to maintain the integrity of such web sites.

### SUMMARY OF THE INVENTION

According to one aspect of the present invention there is provided a web site analysis system comprising:
a crawler adapted to download data of a target web site and associated with a target web site for security analysis to provide a data set for analysis;
a process controller adapted to control a plurality of data analysis processes, each data analysis process associated with one of a plurality of analysis functions related to web site security and integrity, and each data analysis process being adapted to identify data relevant for its associated analysis function from within the data set for analysis;
an analyser adapted to aggregate the data identified by each of the data analysis processes, analyse the aggregated data to perform each of the analysis functions to identify indications of any potential security and integrity problems and generate a report of potential security problems.

The analyser can include an aggregator adapted to aggregate the data identified by each of the data analysis processes.

An embodiment of the analyser includes one or more analysis engines adapted to analyse the aggregated data to identify potential security and integrity problems.

Each analysis engine can be adapted to perform an analysis function to identify indications of potential security or integrity problems from the aggregated data.

The analyser can include a report generator adapted to generate a report representing any potential security and integrity problems in human readable form.

The report generator can be adapted to present data associated with potential security and integrity problems based on the type of potential security or integrity problem.

The plurality of different analysis functions can include any one or more of: malware identification, page ranking, change detection, software version checking, server version checking, broken link detection and server error detection.

Some embodiments of the system further comprise a subscriber module adapted to administer subscription to a web site analysis service.

The subscriber module can be further adapted to control periodic web site analysis for the web sites of each subscriber.

The subscriber module can be further adapted to enable subscribers to configure parameters for web site analysis of their subscribed web sites.

An embodiment further comprises a subscriber alert module adapted to send an alert message to a designated contact for a subscriber in the event of one or more specified potential security problems being identified.

The alert message can be sent to the designated contact via a messaging service.

According to another aspect of the present invention there is provided a web site analysis method comprising the steps of:
a) downloading, using a web crawler, data of a target web site and associated with a target web site for security and integrity analysis to provide a set of data for analysis;
b) storing the downloaded data in a data repository;
c) identifying data relevant to a plurality of security and integrity analysis functions using a plurality of data analysis processes, each data analysis process associated with one of a plurality of security and integrity analysis functions;
d) aggregating using an aggregator the data identified by each of the data analysis processes;
e) analysing, by a computer processor, the aggregated data to perform each of the analysis functions to identify indications of any potential security and integrity problems; and
f) generating automatically by a computer processor, a report of any potential security and integrity problems.

An embodiment of the method further comprises the step of Subscribing to a web site analysis service.

Steps a to f can be performed periodically for the web sites of each subscriber.

The method can further comprise the step of a subscriber configuring parameters for web site analysis of their subscribed web sites.

The method can further comprise the step of sending an alert message to a designated contact for a subscriber in the event of one or more specified potential security problems being identified.

### BRIEF DESCRIPTION OF THE DRAWINGS

FIG. 1 is a block diagram of an embodiment of a system according to the present invention

FIG. 2 is a diagram of an example of a system of the present invention

FIGS. 3a and 3b are a flowchart showing a web site security analysis process in accordance with an embodiment of the present invention

FIG. 4 is a block diagram of an alternative embodiment of a system according to the present invention

### DETAILED DESCRIPTION

Embodiments of the present invention provide a method and system for analysing the security and integrity of one or more web sites. The system enables a plurality of potential security or integrity problems to be assessed and reported. The potential security problems may relate to malicious activity, unauthorised changes, security problems associated with versions of software etc. Problems with integrity of the web site, in addition to security problems, can include broken links or other problems which can cause content or server access errors. Embodiments of the present invention enable a web site to be analysed to detect a plurality of different potential problems.

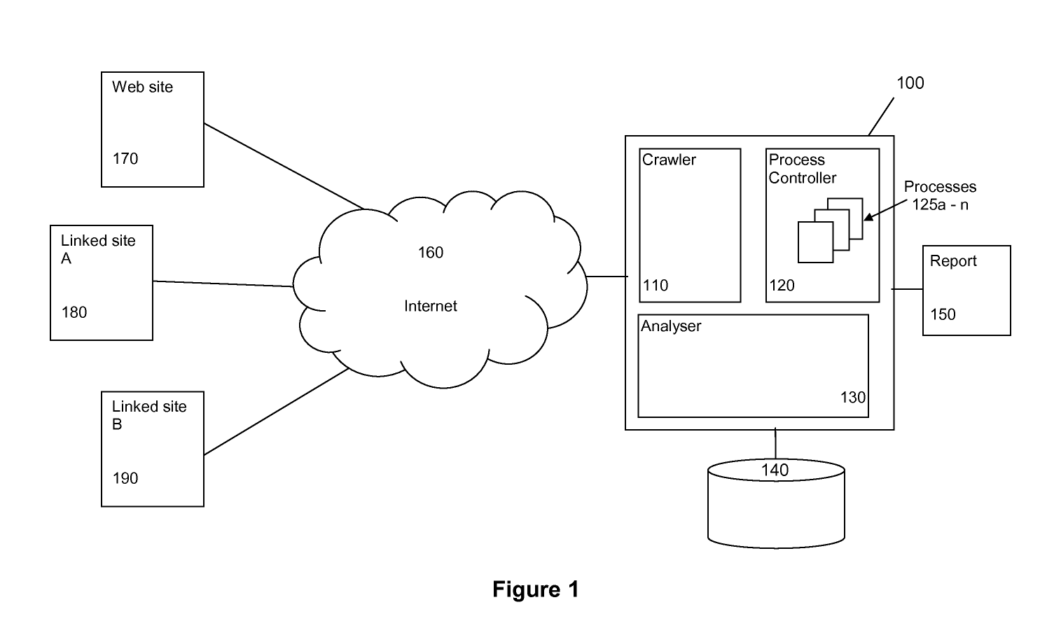

An embodiment of a system 100 of the present invention, as illustrated in FIG. 1, comprises a crawler 110, a process controller 120 and an analyser 130.

The crawler 110 is adapted to download data of a target web site and associated with a target web site for security analysis to provide a set of data for analysis. The processor controller 120 is adapted to control a plurality of data analysis processes. Each data analysis process is associated with one of a plurality of analysis functions. Each data analysis process is adapted to identify data relevant for its associated security or integrity analysis function from within the set of data for analysis. The analyser 130 is adapted to aggregate the data identified by each of the data analysis processes, analyse the aggregated data to perform each of the analysis functions to identify indications of potential security and integrity problems and generate a report 150 of potential security and integrity problems.

The crawler 110 is adapted to download data of a target web site 170 and any data associated with a target web site for analysis. The crawler can be implemented using any suitable web crawler software. The crawler process downloads all data from the target web site 170. For example the crawlers downloads the HTML file defining the web sites and any content such as images, text, video files, audio files, scripts, software etc, encompassing the entirety of content of the web site 170. The crawler can be further adapted to also identify any links to other web sites 180 in the target web site 170 and also download all data of all the secondary linked web site 180. Any links found on these secondary web sites 180 and also be followed and all data of any tertiary linked web sites 190 downloaded. It should be appreciated that the crawler can be adapted to determine whether the data for a linked web site has already been downloaded and such web sites be skipped. Thus the crawler only downloads data from newly identified linked web sites each time. The crawler can be adapted to follow links until end criteria is met. For example the end criteria may be no further newly identified linked web sites being found, a threshold data size reached, a threshold number of links followed, a threshold level of subsequent links followed (e.g. no following links beyond tertiary web sites) etc. Such end criteria may be configurable. Essentially the crawler enables a comprehensive image of the target web site and any web sites of a web site network linked via to the target web site to be captured and stored for analysis.

All data downloaded via the crawler 110 is stored in a data repository 140 accessible by the system. This data provides a data set for analysis which can be accessed by the processes for analysis. The repository can also store data from previous analysis of the same web site. The repository may be any suitable data storage facility. For example, the data repository 140 may be a database connected to the system 100. Alternatively, the data repository 140 may be implemented using a plurality of secure databases or other memory facilities accessible by the system via a server. Alternatively the data repository may be implemented as part of the system 100, for example the data repository may be server memory resident in a server also used for implementing one or more of the crawler 110, processor controller 120 and analyser 130.

The process controller 120 is adapted to control a plurality of data analysis processes 125a-n. Each data analysis process is associated with one of a plurality of analysis functions. For example, the security and integrity analysis functions may include malware identification, page ranking, change detection, software version checking, server version checking, broken link detection and server error detection, etc. It should be appreciated that any suitable analysis function may be included and further security and integrity analysis functions may be added. For example, security analysis functions may be added to address further security threats. Further integrity analysis functions may be added to address ways in which the usability and performance of a web site can be degraded. It should be appreciated that the architecture of using separate processes enables the system to be easily adapted and scaled to address new security or maintenance challenges as these arise in the future. The process controller can be implemented using any suitable combination of hardware, firmware and software. For example, the process controller may be implemented in software, firmware or combination thereof executing on a server or other suitable processor hardware.

Each data analysis process 125a-n is adapted to identify data relevant for its associated analysis function from within the set of data for analysis. The analysis processes can be implemented in software. In an embodiment the processor controller can be adapted to instantiate a plurality of processes each of which operate independently to analyse portions of the data. The number of processes can be based on the amount of data and system capacity to provide rapid analysis of the data. Each security process outputs a data identified as relevant to the security or integrity function associate with the process.

The analyser 130 is adapted to aggregate the data identified by each of the data analysis processes. For example output from each process can be aggregated into an XML data structure. This data structure can then be used for further analysis. Analysis functions are performed on the aggregated data to identify indications of potential security or integrity problems. A report is then generated which presents any potential security and integrity problems in human readable form. The analyser can be implemented in software, for example as a software application executing on a server. It should be appreciated that any suitable combination of software, firmware and hardware can be used to implement the analyser.

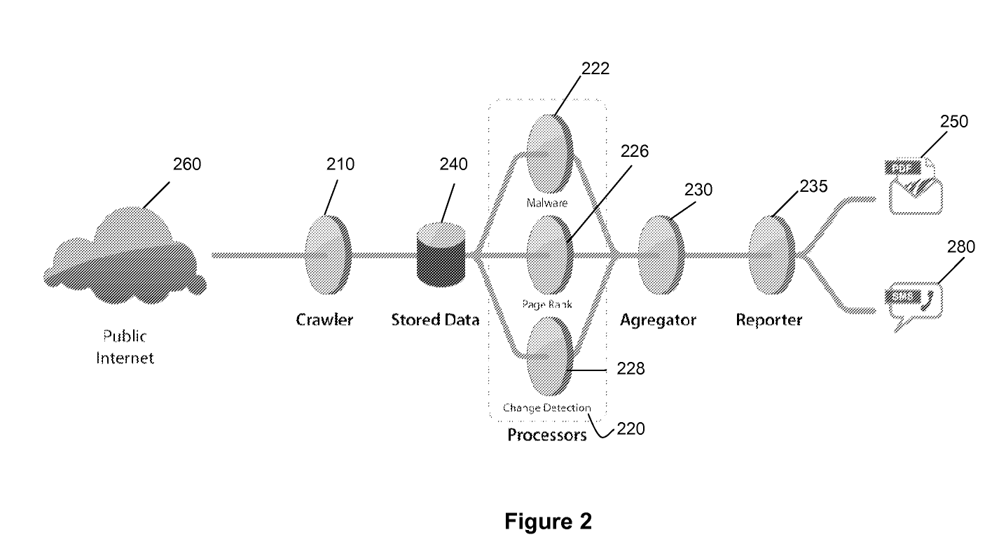

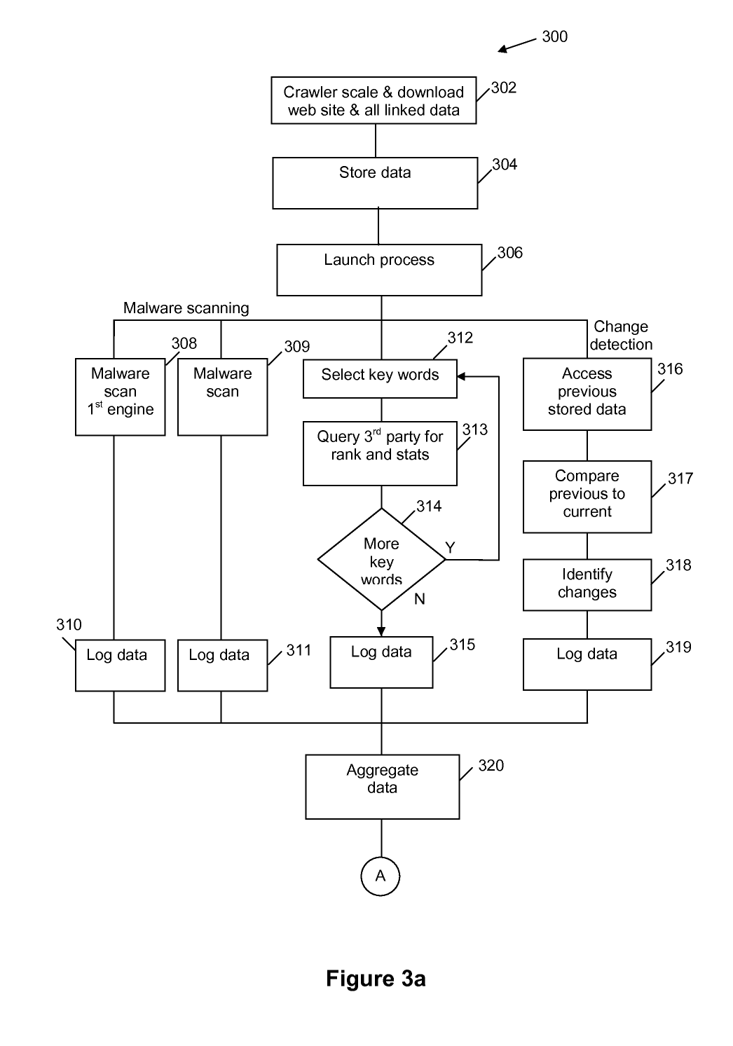

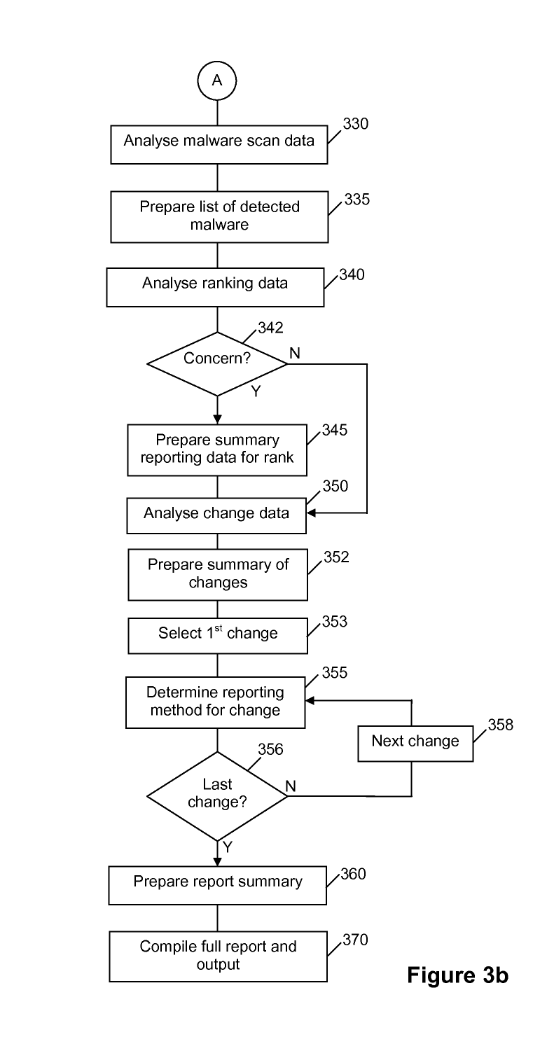

An example of a process for performing security analysis will now be described with reference to an embodiment of the system illustrated in FIG. 2 and the flowchart of FIGS. 3a and 3b.

The system 200 of FIG. 2 comprises four modules: a crawler 210, a processor controller 220, an aggregator 230 and a report generator 235. These modules operate sequentially and are able to be initiated at variable frequency to allow regular ongoing monitoring of a Web site's health. The tool can be implemented in a multi-part workflow of processes triggered by timer events at requested intervals.

The process 300 begins by downloading known content. The crawler 210 first downloads the website 302. All resources (images, stylesheets, scripts and any other content) associated with the web site are downloaded. The crawler 210 then follows detected links to any offsite linked pages by parsing each downloaded page looking for links. The crawler follows all detectable links until there it has spidered (all content captured and links followed) the entire website. In this embodiment the crawler finds and downloads any data available that is related to the target web site. This data is stored 304 in the data repository 240 ready for the processes 222, 226, 228. The data repository 240 can also store data from one or more previous scans of the web site.

The processor controller 220 controls the launch 306 of a plurality of analysis processes 222, 226, 228. Each process is associated with a security or integrity analysis function. The number of processes launched can be based on the number of analysis functions and size of the data. The processes can operate simultaneously for efficient processing of the data. For example, the system may take advantage of parallel processing within a single processor or distributed processor architecture for execution of two or more processes simultaneously. The processor controller 220 triggers the execution of the processes and can also allocate sections of the data for analysis by each of the processes.

Each process can be implemented as a software program. Alternatively, processes may be implemented in hardware and firmware. For example, ASIC (application specific integrated circuits), FPGA (field programmable gate arrays) or other types of data processors may be designed to perform specific data analysis functions under control of the processor controller. Such implementations utilising specific hardware may provide processing speed and efficiency advantages compared to a software embodiment executing using generic hardware resources. Programmable hardware and software implemented embodiments have the advantage of being able to be adapted more rapidly to new security threats, such as new types of malware or new styles of malicious attacks on web sites. Software implementations also provide potential scalability advantages, particularly where distributed hardware processing resources are used.

In an embodiment the process controller can be adapted to utilise networked processor resources available via the internet or other communication network. In such an embodiment the process controller requests access to hardware processing resources via the network. This request and resource allocation may be made through a distributed processing service hosted on the network, for example Amazon's cloud services. Resources, such as server instances are initiated and made available in response to user requests. The service provider manages the hardware resources and multiple users can purchase processing capacity of these hardware resources. Thus each user can request and be provided access to the capacity required, at the time. The service provider spools up as many server instances are needed to fulfil the requirement of the user at the time. This enables the processing capacity to be easily increased and decreased as required. The process controller is provided with access to as many servers as necessary. The plurality of processes can be executed on the network accessible processor resources.

Each of the processes is associated with a security or integrity analysis function. Each process is adapted to identify the data relevant to its associated security or integrity function from the set of data downloaded by via the crawler. Some processes can be software programs developed specifically for the associated security function.

The embodiment of FIGS. 2 and 3 includes three analysis functions are provides, these being malware scanning, page ranking determination and change detection. Each process is adapted to scan through the data downloaded from the web site, and linked sites, to identify data that relates to the particular security or integrity problem associated with the process.

Malware Scanning

In the embodiment of FIG. 3, two malware scanning processes 308, 309 are launched. Each malware scanning process 308, 309 searches the data for any data indicative of malicious software of activities. Malicious activities can include but are not limited to infection of the web site by a computer virus, injection of malware, phishing attempts, etc.

A computer virus is a software program that can copy itself and infect a computer, viruses attach themselves to another computer programs or content and are spread to user's computers when the user uses the infected content or program. A virus may not affect the website itself but use the web site as a distribution channel, copying itself to programs or content being downloaded by users who access the site. Malware (malicious software) is software designed to infiltrate a computer system without the owner's informed consent. Such malicious software can include types of computer viruses, worms, Trojan horses, spyware etc. Worms are self replicating computer viruses which uses a computer network to send copies of itself to other computers without requiring any user intervention or needing to attach itself to another computer program. Trojan horses are software programs which appear to provide functionality of legitimate interest to a user but hide software which facilitates unauthorised access to a user's computer system. Spyware is software which collects information about users without their knowledge. Phishing is an attempt to acquire sensitive information by masquerading as a legitimate entity, for example using a bogus web site.

Malware scanning process 308 is a malware scanning engine adapted to identify at least one type of malware within the data being scanned. For example, the types of malware that may be detected can include computer viruses, phishing attacks, java script injected into the site etc. The malware engine is adapted to detect code or data within the data downloaded from the web sites that may be associated with known or unknown malware. For example, scripts or software that have been maliciously attached to other data or embedded in other programs may be identified. Such malware detection engines can also be known as anti-virus engines. Malware engines can detect known malware by identifying signature data, scripts, code etc, of the malware. Identification of unknown malware can be more difficult. Unknown malware, or data which may indicate the present co unknown malware, may be identified by scanning for inconsistencies in data, scripts or programmes. Alternatively, known scripts or executable instructions which are often used in malware may be identified, for example, instructions known to be used to link to the malware or graft the malware to another program.

Malware scanning process 309 can be a different malware scanning engine also adapted to identify at least one type of malware. Malware scanning process 309 can scan the same data as malware scanning process 308. Using two or more malware engines for the same data has the advantage that more potential security problems may be identified. For example, a potential problem, such as a virus, may be detected by one malware engine and not another. Thus, by using two different malware engines mare potential problems may be identified. Different malware engines may use different detection techniques making some better adapted to identify some problems than others, particularly in relation to unknown malware. Alternatively some malware detections engines may be update more quickly by their providers than others when new malware becomes known or new software versions are introduced. Thus, using two or more different malware engines provides some redundancy in the system and potentially improves the identification of potential malware problems. Either one or both engines may identify a potential security problem.

Any data indicative of potential malware identified by the malware scanning processes 308, 309 is logged 310, 311 for further analysis. For example, the logged data can include: an identification of the potential problem, the data address defining location of the data in the data repository 240, any associated data indicating the area of the web site that may be affected, any links associated with the potential problem etc.

Web Site Ranking

Web site ranking can provide important feedback to a web site owner. For example, ranking may indicate how popular a web site is compared to other web sites or where a web site first appears within a set of search results compiled by a search engine. Ranking of a web site, and in particular changes in ranking for a web site can also be indicative of problems with a web site. For example, any significant drop in popularity of a web site can indicate a potential problem which may be related to web site security or usability.

The ranking process 226 is adapted to identify where the web site ranks on one or more popular search engines. The ranking process can also be adapted to acquire statistics from third party libraries which can be used to indicate the use and/or popularity of the web site. Examples of third party web site ranking services that may be queried include Alexa and Google web site ranking information services. However, any third party web site ranking services may be used. The web site ranking process may be adapted to query more than one web site ranking service.

The downloaded web site data can include information related to each webpage such as outgoing links, incoming links and keywords. The page ranking process can use this data for querying search engines or libraries. For example, as illustrated in FIG. 3, a first keyword or set of keywords is selected 312 and a query 313 sent to each of one or more search engines or search engine providers to determine where the web site would appear in a results ranking. Such search engines can be independent of the web site, for example third party search engines. In some instances a search is performed by the third party search engine in response to the query 313. The search result can then be scanned by the page ranking processor to determine at which rank the web site or any of the linked sited appear in the search results. For example, the web site may appear as the 728^{th} web site listed in response to the key word search. Alternatively the third party search engine may be adapted to provide statistics data for a give web site including the page rank of the site for one or more given key words. Other information which may be provided can include hit data for the web site, indicating how many times the link to the web site was followed form the search, the number of searches performed with the given key words etc. This process can be repeated 314 for a selection of key words and the data logged 315.

The page ranking data can be used to detect any change in ranking for the web site by comparing current and past raking data. In particular a drop in page ranking can be indicative of a problem with the web site.

Search engines send traffic to specific web sites via unpaid algorithmic search results, or through paid inclusion in search results. Web site content and coding works to increase the site's relevance to specific keywords and to optimise indexing by search engines. These methods are intended to improve a web site's ranking, to appear higher on the indexed results of the search.

Websites can be affected by accidental/human errors, for example, links broken, inappropriate keywords which can affect search index results. Further, deliberate attacks can affect search index results. Some examples of deliberate attacks which can affect search index rankings include: injection of malware; phishing, where malicious web sites appear to be legitimate and deceive users into believing transactions or activities are legitimate; and search index poisoning which is deliberate manipulation of rankings, again sending users to compromised web sites.

Not only business networks and communications, but reputation and trust can be destroyed by users landing on an insecure, damaged or infected branded website.

The magnitude of the change in ranking can be an indication of the severity of the problem. For example, if a web site no longer appears in a key word search this may indicate that the web site has been barred by the search engine, for example if a virus is detected on the web site or a link to a malicious (e.g. phishing) site been attached to the web site. If a web site has dropped from rank 728 to 1128 this represents around a 35% drop in web site ranking. Such a dramatic change may be caused by a problem such links to content being broken or content containing the key words deleted, or search index poisoning. A reduction in hit rate may be indicative of users moving away from using the site, for example in response to usability problems such as broken links. For example a 10% drop in hits may indicate 10% of a web site owner's customers moving away from their service, where a web site is an organisation's customer service interface this can be of significant concern to the web site owner. Techniques are known to protect web site visitors by preventing transmission of threats through browsing web sites and to report to users on whether viruses or malware may be present on computers or web sites. Embodiments of the present invention are adapted to mitigate the risk of reputation or commercial damage to a web site owner through proactively monitoring of the web site. Thus an advantage of monitoring web site ranking is enabling early detection of problems either with the web site itself or the search indexes.

Change Detection

The change detection process 228 is adapted to identify any changes that have occurred in the web site since the last security scan. Whether or not the change is legitimate or malicious, all changes can be identified and logged. The change detection process 228 accesses the data stored for the previous web site scan 316 and compares the previous scan data with the data downloaded for the current scan 317. Changes are identified 318 using any suitable change detection method 318. For example, text comparison can be used for comparing current and previous text content including source HTML, XML files scripts etc, as well as text content. As all content associated with the web site has been downloaded all content can be compared between the two sets of content. For example, the change detection process can be adapted to detect a change in the content of a linked file even if a file name and version remains unchanged. Changes to file names and addresses or deletion of content is also detected as, among other problems, this can give rise to broken link problems which can degrade the usability of the site.

Data for all identified changes is logged 319. The logged data can include information such as the location of the change, nature of the change, timing of the change (if this can be determined), party responsible for the change (if this can be determined), etc. Any data available associated with the change may be logged 319.

Additional processes may also be performed.

The operation of the processes filters the data originally downloaded from the web site to identify data that may be associated with potential security or integrity problems. Each data analysis process is associated with a security or integrity analysis function and therefore filters the data from the perspective of that analysis function. Data recognised as relevant for the function of each data analysis process is logged by each data analysis process.

Next, the aggregator 230 takes all the data logged by the various processes and aggregates the data 320. The data is aggregated into a single data structure, such as an XML (extensible mark up language) data structure. The data structure can then be used to generate a single document that reports on each and every object downloaded as well as summarised aggregations of this data.

The aggregator can be adapted to combine results from two or more processes associated with the same function, for example to order data, remove duplicate results etc. The data is stored in a data structure, such as an XML file or database, for further analysis.

The reporter 235 is adapted to analyse the aggregated data. The reporter 235 summarises the collected data into a human-readable form and outputs a PDF consisting of an overview of the scan and a detailed report of any issues found. The reporter 235 applies analysis rules to the data to identify and prioritise potential security risks or integrity threats and generate a report. The reporter 235 is also adapted to determine how to represent the information in the report. This can include determining what data needs to be included in the overview and the manner in which to present data in the detailed report.

The malware scan data is analysed 330 to determine whether or not any malware has been detected. A list of any malware detected is prepared 335 for inclusion in the report. It should be appreciated that any detection of malware or potential malware is of high importance to the web site owner. Malware can compromise a web site's operation or infect customers. Further, an infected site may be blocked by firewalls or from search engines. Thus the impact of malware can seriously affect business operations and commercial reputation. Due to the severity of the potential impact of malware, any potential malware detection is given a high priority by the reporter 235.

Where more than one malware engine is used to process the web site data the results from all of the malware engines can be compared. Rules applied for combining and reporting the results from two or more malware detection engines can vary between embodiments. In one embodiment potential malware detection by any one or more of the malware detections engines is reported. The order in which any detected malware is reported can vary depending on the embodiment. For example, malware detected by only one malware detection engine may be listed first as this may represent new or obscure malware that may be more difficult to treat than common malware more likely to be detected by all the malware engines. Alternatively, a higher ranking may be given to the malware detected by more than one malware engine.

In an alternative embodiment only malware detected by more than one malware detection engine may be reported as a definite/confirmed detection and given high priority. Malware detected by only one malware engine may be reported as possible detection and reported for further investigation.

The web site ranking data is analysed 340 to determine whether or not there is any cause for concern 342. For this analysis current web site ranking data is compared to previous web site ranking data. For example, any improvement in web site ranking is a positive change and is unlikely to represent any security or integrity risk. In such an instance the direction and magnitude of the change be noted for the report. However, as no potential problem is indicated no data is required for the report overview.

A drop in ranking may indicate a problem. The magnitude of the drop can be determined. Typically the analysed magnitude will be a relative magnitude or percentage change rather than an absolute value. However, in some embodiments absolute magnitude may be used.

The magnitude of the drop can be used to distinguish between a drop resulting from a problem and a drop caused by regular usage fluctuations. For example, the traffic for a web site and web site ranking may regularly fluctuate by around 2-5%. Any fluctuation, in particular in a negative direction, greater than this regular fluctuation, may indicate a problem. Analysis rules may include a defined threshold drop for indicating a problem. Several threshold values may be used with the value based on severity of the potential problem. For example, where the magnitude of the drop exceeds a given threshold, for example greater than 7%, this can be indicative of a minor problem, such as broken links or problem with the usability of the site causing the site to be avoided. When a drop exceeds a magnitude of 10% this may indicate a larger potential problem, for example an indexing problem, particularly if a substantial ranking change is shown by one third party search engine but not another. A drop exceeding a magnitude of 25% can indicate a serious problem, such as malware, which requires further investigation.

Ranking data is then prepared for the report 345. A summary of the change data can be prepared for the overview indicating the magnitude of the negative change. Further change data can be provided in the full report. For example, the full report may show which third party web site ranking service showed what change.

The change data can then be analysed 350 by the reporter 235. In the current embodiment no assessment is made of whether or not a change is malicious or authorised. Any change in the document is identified and reported. The reporter may be adapted to perform a first pass analysis of the changes to determine the number of changes of each type 352. This summary may be used for the report overview. The reporter 235 the selects a change 353 and determines a reporting method to use for the change 355. This process is repeated, with the next change being selected 358 each time, until a reporting method for each change has been selected 356.

The manner in which each change is reported is based on how the change can be effectively represented in a human readable form. For example, where a change is an image change, both the new and old changes may be represented side by side in the report. Text changes may be shown using red line mark up changes or changes otherwise highlighting the changes. Where changes relate to links, the link address and status of the linked files may be identified, deleted content may be listed and marked as deleted along with any links to the identified content remaining in the web site identified as these will give errors. The deleted content itself may be shown. It should be appreciated that changes can be presented in any suitable manner. The reporter is adapted to select the manner in which each change will be presented in the report. This can make it easy for a person reviewing the report to see what has been changed.

In some embodiments the reporter may use several passes to prepare the change data, which each pass addressing a different type of change. For example, a first pass may report all link changes, a second pass may report all deleted content, a third pass may report all added content, a fourth pass may identify all modified content which may be grouped by type, a fifth pass may report all coding changes, a sixth pass may identify formatting changes etc. The order for reporting the change data may vary between embodiments.

The reporter 235 prepares a report summary 360 providing an overview of the potential problems identified. The body of the report is then compiled 370 providing details of each potential problem identified in a human readable form. The report can be provided to a web site owner, for example via e-mail in a PDF file format or via a web interface. The reporter module 235 can also interact with SMS services to instantly alert website owners in the case of an extreme-risk event, such as malware injection.

The report overview is adapted provide a high level indication of potential problems. A person, such as a manager, can then either use the body of the report to obtain further detail of the problems or instruct web support personnel to investigate the problems based on the information provided in the body of the report.

In some embodiments the order for the report may be configurable. For example a web site owner may specify a desired order for report content.

It should be appreciated that the system provides a single tool to scan, analyse and report on multiple elements of the specified Website's functionality, security and integrity. Use of the system can reduce the risk to the Website owner of deliberate or accidental Web site damage being undetected.

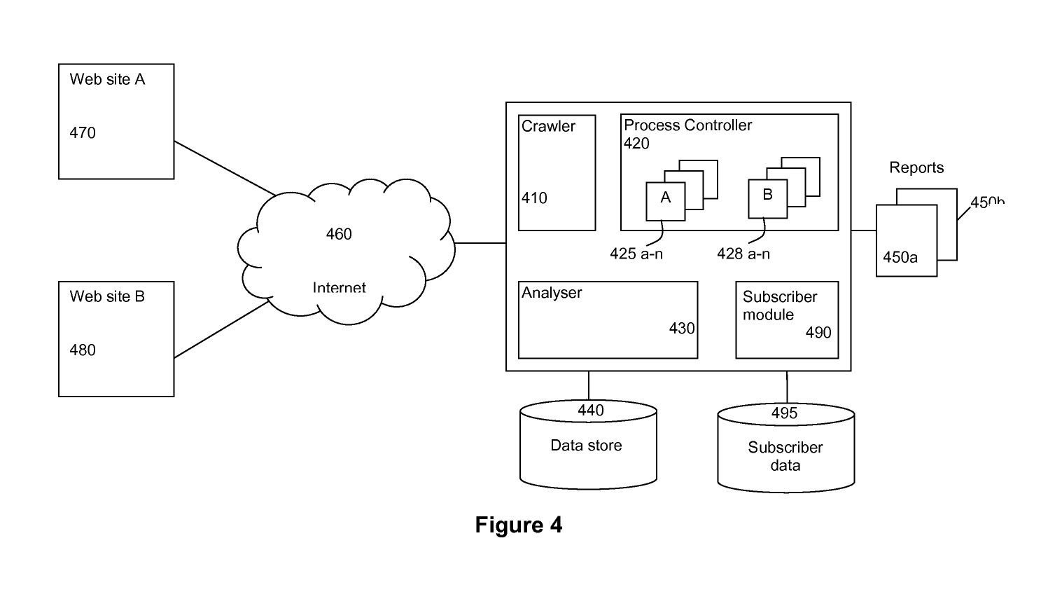

Some embodiments of the system enable the web site analysis to be provided as a hosted service to one or more subscribers. In the example illustrated in FIG. 4 the system 400 comprises a crawler module 410, a processor controller 420, analyser module 430 and a subscriber module 490. The system is in communication with or comprises a data store 440 for storing web site data and a subscriber database 495 for storing subscriber data.

The subscriber module 490 can provide an interface to enable web site owners to subscribe to the service. For example web site owners may subscribe via a web site or customer service centre linked to the subscriber module. The subscriber module can be implemented as software executing on a server or any suitable combination of hardware, firmware and software. Subscribers are typically web site owners who subscribe to the service, but subscribers may also be third parties responsible for the design and maintenance of owner's web sites.

The subscriber module includes functionality for acquiring subscriber details including the address of the target web site, requested frequency of security and integrity scanning, payment and correspondence details etc. For example, a subscriber may request monthly, weekly or daily security scanning. In some high risk businesses more frequent security scanning may be requested. For example, high traffic financial transaction web sites, such as escrow agents or banks, may request scans be performed every 8 hours rather than daily. The frequency of the scan can be configured for each subscriber. Subscribers may also be able to configure report generation parameters and security alert parameters according to their needs. The subscriber data and subscriber parameter values are stored in a subscriber database 495.

The subscriber module can be adapted to trigger the start of a web site security scan for the web sites of each subscriber in accordance with the subscriber's request. For example, the subscriber module may maintain a list of all web sites that are to be scanned monthly, weekly, daily etc. and send a command to the web crawler module 410 to initiate the scan for each web site at the appropriate interval.

The subscriber module can be adapted to queue web site analysis requests for execution. In some embodiments the analysis for each web site is performed sequentially, where the subscriber module initiates analysis of the next web site in the queue once the analysis is completed for the previous web site. In alternative embodiments two or more web sites may be analysed in parallel. In such embodiments the system is adapted to use multiple instances of web crawlers, processes and analysers to enable parallel processing of web sites. In yet a further alternative embodiment, each of the web crawler, processor controller and analyser modules can be triggered independently. In such an embodiment the each module may be operating for a different web site at the same time. For example, the web crawler 410 can be triggered to download the first web site in the queue. Once this is completed the processor controller 420 can be triggered to launch data analysis processes for the first web site. The web crawler 410 can then be triggered to download the second web site in the queue. Thus, the next web site is being downloaded while the data for the first web site is being scanned. Similarly once the data analysis for the first web site is completed the analyser can be triggered to aggregate the data for the first web site and generate a report. The processor controller 420 can be triggered to scan the data for the second web site while the analyser 430 is operating on the data from the first web site. Likewise the web crawler 410 can be triggered to begin downloading data for a third web site. Thus analysis can be performed at different stages for several web sites simultaneously.

The number of web sites that can be handles simultaneously can be based on the number of separate modules and processing stages. For example, if data aggregation and report generation are separated into separate processes as illustrated in FIG. 2, processing at four different stages of four web sites may be performed simultaneously. Using a combination of parallel processing and simultaneous processing of different stages are used in combination more than four web sites may be analysed at the same time. It should be appreciated that the number of web sites that may be analysed concurrently is dependent upon the system architecture and all possible variations are encompassed within the scope of the present invention.

The operation of the crawler module 410, processor controller 420 and analyser 430 are similar those described above in relation to FIGS. 1 and 2.

The crawler module 410 sends web crawler robots to each target web site 470, 480. The web crawler robots are instances of software programs that find and download the data of their target web site and any linked sites as described above. Data storage space is allocated in the data repository 440 for each target web site 470, 480.

The processor controller 420 is adapted to launch processes for performing data analysis on the downloaded data for each of the target web sites 470, 480. For example, a first set of processes 425a-n can be launched to analyse the data form target web site A 470 and a second set of processes 428a-n can be launched to analyse the data for web site B 480. The processes 425a-n, 428a-n may not all be launched simultaneously. For example, if web site A 470 is much larger or has more linked sites than web site B 480, the web crawling for web site A 470 may take more time than for web site B 480. The processor controller 420 may therefore launch the processes 128a-n for analysis of the web site B data before the processes 125a-n for analysis of the web site A data. The data analysis is performed for each of the web sites as described above with reference to FIG. 3.

The analyser 430 is adapted to aggregate the data analysis results for each web site. A separate data structure is used for the data from each web site. The data for each web site is analysed separately and a separate report 450a, 450b generated for each web site 470, 480.

Some embodiments enable subscribers are able to configure preferences for web site analysis and reporting. For example, subscribers may be able to configure: the types of security analysis included in the scan; period of the scan; data limits or link tree limits, which may be associated with a level of service and subscription cost; order of priority for reported potential security problems; summary page layout preferences; contact for report delivery (i.e. e-mail addresses); emergency contact details and preference, for alerting the subscriber in the instance of a serious problem etc. This subscriber configurable data can be used when preparing the report and each report 450a, 450b may therefore appear different.

Each subscriber may also be able to configure alert conditions, where contact to one or more designated emergency contacts for the subscriber will be made, for example via SMS message. A default alert condition may be set where any detection of malware causes an alert to be issued. A subscriber may be able to change the alert conditions for their site. For example, an alert may be also sent for any change detected in the web site. The alert may be sent to a web site administrator who can then determine whether or not the change was authorised. Other alert criteria, such as change in ranking, detection of broken links, etc may be used.

It should be appreciated that embodiments of the present invention provide a single system adapted to scan a web site for multiple problems with the security and integrity of the site. Aspects which affect the integrity of a web site are not just related to potential security problems but can include links being broken, inconsistent content changes, obsolete software versions being used, server errors etc. Many of these problems relate to degradation of the user experience with the site rather than security risks. The present system can enable such problems, as well as potential security risks, to be proactively detected. An advantage of embodiments of the present invention is provision of a holistic detection tool to identify intrusions, infections or other damage to their sites, often being unaware that any intrusion has occurred.

A further advantage of some embodiments of the system is that the web site analysis can be provided as a subscription based service to users. Thus, the service and be utilised to reduce the time and capacity required by a web site administrator to perform security and integrity check of the web site. This can improve efficiency and reduce the cost for web site maintenance. Further, the service provider can be actively maintaining the scanning capability to address any newly developed malware or other problems to enable the most up to date scanning technology to be made accessible to all subscribers. This alleviates the need for web site administrators to actively administer web site security detection measures.

Embodiments of the invention have been described above in relation to periodic scanning of web sites. However, embodiments may also enable scanning to be performed in response to a user request. For example, a subscriber may request a scan of selected pages or the whole web site in between scheduled scans. For example, a scan may be requested after updating a section of the web site to check whether any integrity problems, such as broken links, or security problems, such as malware been introduced during the change. Alternatively, if a server has an excessive number of failed log in attempts a scan may be requested to aid diagnosis of the cause of the failed login attempts.

Embodiments of the invention have been described which scan for malware, changes to the web site and web site ranking. However, scanning for many other potential problems can also be performed. For example, scans may be adapted to look at the health of the servers hosting the web site and linked sites to detect server errors, check web server versions, check software versions (e.g. PHP, Perl, Java etc), check content management systems (CMS) versions, detect error pages (e.g. 404 page not found errors & 501 server error pages) etc.

Some embodiments of the system may also be adapted to include or link to modules for treatment of detected problems. For example, embodiments of the invention may include or trigger a treatment module adapted to launch programs to remove or mitigate detected malware from the web site, where a known fix is available. Triggering the program to mitigate malware may be performed automatically by the system or in response to a user request.

A treatment module may also include a program adapted to restore modified content to a previous version, for example in response to a user request where an accidental or unauthorised change has been made. A program may also be provided which is adapted to mend broken links, for example a user may enter a corrected link address for a broken link and the program be adapted to replace all broken links with the corrected address. All possible treatment options are contemplated within the scope of the invention. An advantage of providing such treatments through the web site analysis system is that the web site analysis system stores data of current and previous web site versions, thus enabling restoration of lost data. Further, the system can offer the advantage of a single interface for analysis and treatment of multiple problems which may affect the web site.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A web site analysis system comprising:
a crawler adapted to download data of a target web site and associated with a target web site for security analysis to provide a data set for analysis;
a process controller adapted to control a plurality of data analysis processes, each data analysis process associated with one of a plurality of analysis functions related to web site security and integrity, and each data analysis process being adapted to identify data relevant for its associated analysis function from within the data set for analysis;
an analyser adapted to aggregate the data identified by each of the data analysis processes, analyse the aggregated data to perform each of the analysis functions to identify indications of any potential security and integrity problems and generate a report of potential security problems.

2. A system as claimed in claim 1 wherein the analyser includes an aggregator adapted to aggregate the data identified by each of the data analysis processes.

3. A system as clamed in claim 1 wherein the analyser includes one or more analysis engines adapted to analyse the aggregated data to identify potential security and integrity problems.

4. A system as claimed in claim 3 wherein each analysis engine is adapted to perform an analysis function to identify indications of potential security or integrity problems from the aggregated data.

5. A web site security system as claimed in claim 1 wherein the analyser includes a report generator adapted to generate a report representing any potential security and integrity problems in human readable form.

6. A system as claimed in claim 5 wherein the report generator is adapted to present data associated with potential security and integrity problems based on the type of potential security or integrity problem.

7. A system as claimed in claim 1 wherein the plurality of different analysis functions include any one or more of: malware identification, page ranking, change detection, software version checking, server version checking, broken link detection and server error detection.

8. A system as claimed in claim 1 further comprising a subscriber module adapted to administer subscription to a web site analysis service.

9. A system as claimed in claim 8 wherein the subscriber module is further adapted to control periodic web site analysis for the web sites of each subscriber.

10. A system as claimed in claim 8 wherein the subscriber module is further adapted to enable subscribers to configure parameters for web site analysis of their subscribed web sites.

11. A system as claimed in claim 8 further comprising a subscriber alert module adapted to send an alert message to a designated contact for a subscriber in the event of one or more specified potential security problems being identified.

12. A system as claimed in claim 11 wherein the alert message is sent to the designated contact via a messaging service.

13. A web site analysis method comprising the steps of:
a) downloading, using a web crawler, data of a target web site and associated with a target web site for security and integrity analysis to provide a set of data for analysis;
b) storing the downloaded data in a data repository;
c) identifying data relevant to a plurality of security and integrity analysis functions using a plurality of data analysis processes, each data analysis process associated with one of a plurality of security and integrity analysis functions;
d) aggregating using an aggregator the data identified by each of the data analysis processes;
e) analysing, by a computer processor, the aggregated data to perform each of the analysis functions to identify indications of any potential security and integrity problems; and
f) generating automatically by a computer processor, a report of any potential security and integrity problems.

14. A method as claimed in claim 13 the report represents the potential security and integrity problems in human readable form.

15. A method as claimed in claim 14 wherein the report presents data associated with potential security and integrity problems based on the type of potential security or integrity problem.

16. A method as claimed in claim 13 wherein the plurality of different analysis functions include any one or more of: malware identification, page ranking, change detection, software version checking, server version checking, broken link detection and server error detection.

17. A method as claimed in claim 13 further comprising the step of Subscribing to a web site analysis service.

18. A method as claimed in claim 17 wherein steps a to f are performed periodically for the web sites of each subscriber.

19. A method as claimed in claim 17 further comprising the step of a subscriber configuring parameters for web site analysis of their subscribed web sites.

20. A method as claimed in claim 17 further comprising the step of sending an alert message to a designated contact for a subscriber in the event of one or more specified potential security problems being identified.

21. A method as claimed in claim 20 wherein the alert message is sent to the designated contact via a messaging service.
